(19) United States
(12) Patent Application Publication
(10) Pub. No.: US 2013/0174113 A1
(43) Pub. Date: Jul. 4, 2013

(54) FLOORPLAN ESTIMATION

(71) Applicant: ARTERIS SAS, Guyancourt (FR)

(72) Inventors: Jean-Jacques Lecler, SUNNYVALE, CA (US); Boris Boutillier, MONTIGNY LE BRETONNEUX (FR)

(73) Assignee: ARTERIS SAS, Guyancourt (FR)

(21) Appl. No.: 13/723,186

(22) Filed: Dec. 20, 2012

Related U.S. Application Data
(60) Provisional application No. 61/581,639, filed on Dec. 30, 2011.

(51) Int. Cl. G06F 17/50

(52) U.S. Cl. CPC G06F 17/5072
USPC 716/122

(57) ABSTRACT

The disclosed invention gives an estimation of the placement location of the units comprising a NoC within the floorplan of a chip. From that, and with knowledge of the number of wires of links within the NoC topology, an estimation of the wire density at each point is calculated. Furthermore, an estimate is made of the locations of the critical timing paths within the chip. The timing path calculation is also used to generate IO constraints for the synthesis of modules comprising different parts of the NoC. Further still, a scenario of traffic through the NoC is combined with the wire map and information about the width of links within the topology to generate an estimation of power consumption.

### CROSS-REFERENCE

The present application claims priority to U.S. Provisional Application Ser. No. 61/581,639 filed on Dec. 30, 2011 and titled FLOORPLAN ESTIMATOR, the entire disclosure of which is incorporated herein by reference.

### TECHNICAL FIELD

This invention is related to semiconductor technology and, more specifically, to computer-aided design of network-on-chip (NoC) architectures.

### BACKGROUND

There term NoC used herein should be understood to encompass all varieties of interconnections of IP cores within semiconductor chips. Such varieties encompass, though not exclusively, shared busses, crossbars, interconnects, on-chip communication networks, switches, and fabrics.

The designer of a NoC usually focuses on architecture performance aspects such as bandwidth and latency. The designer creates a network topology and provides it to a backend team to perform the physical layout of the chip. The NoC designer usually takes no direction from the backend team and does not consider physical constraint when designing the NoC topology.

Sometimes the backend team discovers that the topology causes severe place and route problems. At that stage of the chip design it is usually too late to change the topology, and the back end team must solve extremely difficult problems in placing and routing network units within the chip floorplan in order to meet design rule constraints. Consequences can include higher power consumption (due to a higher number of high speed gates), a derating of the operating frequency, an increase in die size to resolve congestion, delayed project completion, and even cancellation of the chip design project.

Therefore, what is needed is a system and method for providing the designer of a NoC, early in the chip design process, with an estimate of the floorplan of a chip and what the NoC would look like in order to be able to select between alternative topology choices and the related consequence of each choice and the fundamental problems.

### SUMMARY

One aspect of the disclosed invention is to, early in the chip design process, provide the designer of a NoC with an estimate of what the NoC could look like, physically, in the floorplan of a chip. This enables the designer to foresee the consequences of his or her topology choices on the floorplan, thus minimizing the risk of late-discovered fundamental problems.

According to the various aspects of the present invention, the NoC designer proposes a topology of agents and units and either the NoC designer or backend team proposes a corresponding floorplan. An automated process is used to display the topology usefully within the floorplan. The automated process is generally run on a computer programmed by instructions stored on a non-transitory computer readable medium.

### DESCRIPTION OF DRAWINGS

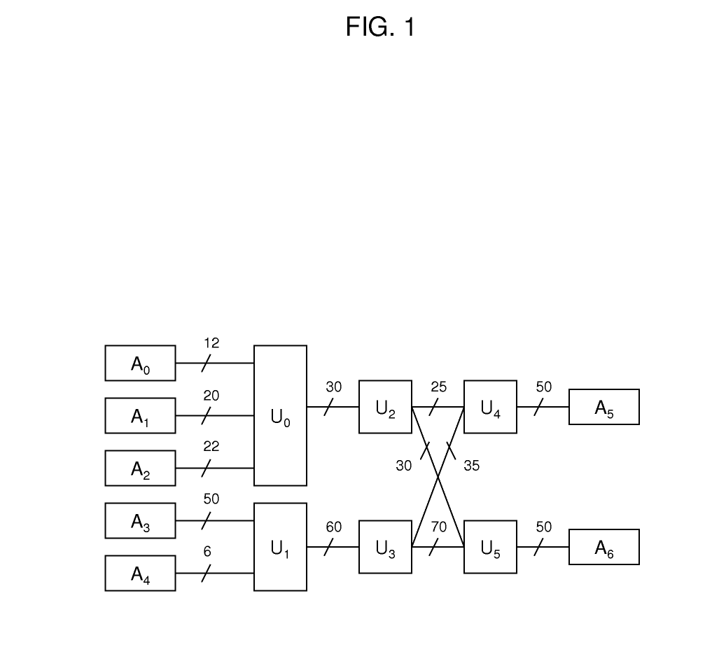

According to the teachings of the present invention, FIG. 1 illustrates one example of a NoC topology.

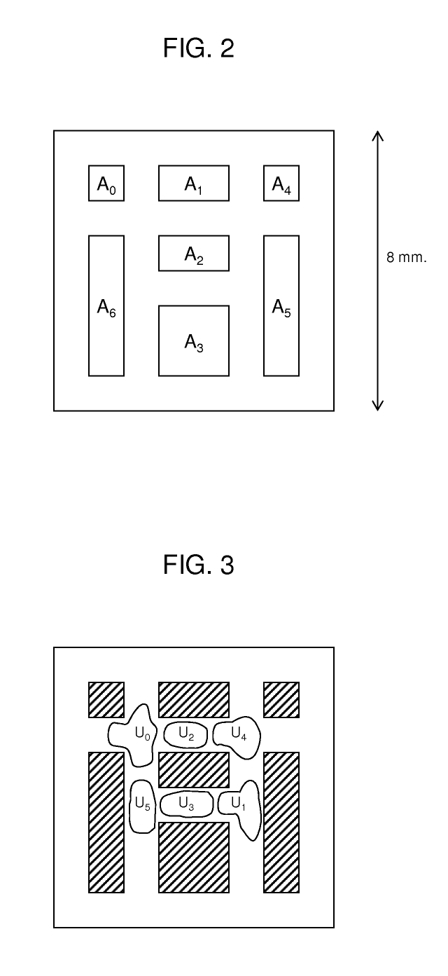

According to the teachings of the present invention, FIG. 2 illustrates one example of the placements of agents within a floorplan.

According to the teachings of the present invention, FIG. 3 illustrates one example of the placement of units within a floorplan.

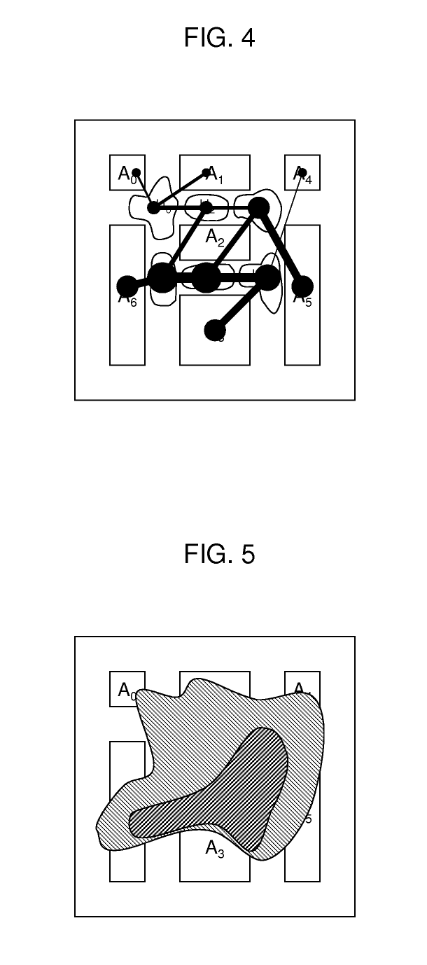

According to the teachings of the present invention, FIG. 4 illustrates one example of a weighted connectivity map.

According to the teachings of the present invention, FIG. 5 illustrates one example of a wire density heat map.

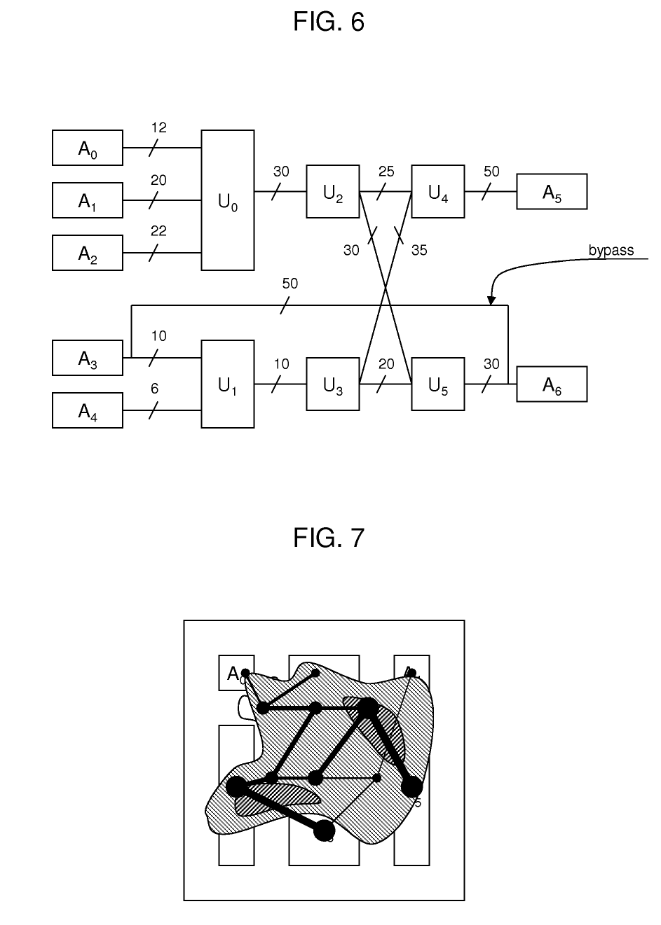

According to the teachings of the present invention, FIG. 6 illustrates one example of an alternate NoC topology.

According to the teachings of the present invention, FIG. 7 illustrates one example of a floorplan map with agents, units, weighted connectivity, and routing congestion displayed.

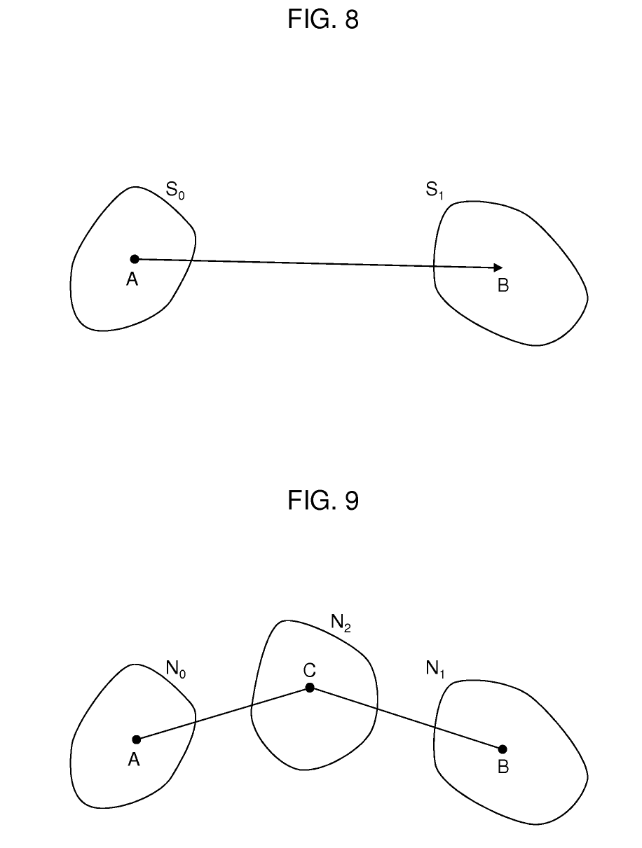

According to the teachings of the present invention, FIG. 8 illustrates a display of two shapes and their median points.

### DETAILED DESCRIPTION

### Terminology

A NoC comprises nodes connected by wires. A NoC can include many nodes. Nodes are either agents or units.

Agents are nodes with a fixed shape within a floorplan. Agents are IP cores such as CPUs and memory controllers.

Units are nodes of a NoC that are topologically between agents. Units generally perform the functions of transporting data transactions between agents. Switches, muxes, and buffers are examples of units.

A NoC can comprise different numbers and different arrangements of nodes.

A topology is a set of nodes within a network and their connectivity. Connectivity can be described in a 2 dimensional table with a row and column for each node. A topology does not necessarily correspond to a physical arrangement of nodes. A topology is shown in FIG. 1. A chip floorplan is shown in FIG. 2. In accordance with an aspect of the present invention, the floorplan is square with 8 millimeters on each side. In accordance with another aspect of the present invention, seven agents and their shapes are shown.

The shape of a node is understood to be the set of the locations of every point within the node. The shape of a node encompasses the lay terms shape, size, and location. The calculation of the shape of units is a subject of the disclosed invention. In accordance with one aspect of the present invention, the shapes of units are irregular, as shown in FIG. 3. Shapes may even be noncontiguous.

### How to Use

One aspect of the invention is a method to estimate a likely placement of the NoC units within the space unused by agents in order to minimize wire routing congestion. An example is shown in FIG. 3 where the shaded regions represent agents. A map of the connectivity of the topology from FIG. 1, overlaid on the floorplan, is shown in FIG. 4. The number of signals in links connecting nodes of the topology are indicated by the thickness of line segments in the figure.

FIG. 5 shows a heat map of the floorplan with distribution of the wire density across the die. Each point has a color, shading, or opacity based on the density of wires. The density takes into consideration the connectivity, the route of connections, and the number of wires of connections.

The invention enables the NoC designer to judge whether or not his tentative topology is layout-friendly. Layout-friendly means that it will require only reasonable effort to perform place and route in the backend design process. When fewer wires between units are required within a region, wires may be routed further apart one from another, thereby reducing the parasitic capacitance and other constraints defined by physical design rules of fabrication process technologies. Reduced parasitic capacitance makes the timing closure easier and allows timing closure with gates that have lower dynamic (switching) and static (leakage) power consumption. This makes physical design within the fabrication design rule constraints easier, and possible with less manual effort.

If maximum density, as estimated in the manner of the invention, is too high or the region of highest density range is too large the NoC designer can change the topology to achieve a better result. Referring now to FIG. 2 and FIG. 3, the wire density in the example floorplan is highest in the areas of units U₁, U₃, and U₅ and agents A₃, A₅, and A₆. It is clear from the topology of FIG. 1 that there is a route of high bandwidth, wide links between A₃ to A₆. An alternative topology is shown in FIG. 6 in accordance with one aspect of the present invention. It has a high bandwidth bypass link between agents A₃ and A₆. With that traffic carried on the bypass link, links U₁, U₃, and U₅ need less bandwidth and are therefore made narrower. In accordance with one aspect of the present invention, FIG. 7 shows the resulting floorplan with wire density heat map and weighted connectivity map. The regions of highest density are smaller and spread further apart. The topology change made between FIG. 1 and FIG. 6, avoids a routing congestion problem between units U₁, U₃, and U₅ late in the chip design process.

### how to Make

As shown in FIG. 4, the lines of connectivity are drawn with endpoints at the geometric centers of units. The shape of the unit determines the endpoints and therefore the wire length. The total wire length of all connections determines the optimal shape of each unit. Since floorplans are expressed as a map on a finite grid of elements, the optimal solution is a linear equation of all floorplan elements, unit sizes, unit connectivity, and number of wires per connection. According to an aspect of the invention, the optimal shape of units is calculated by a linear equation solver. According to another aspect of the invention, the sum of total wire length is calculated by first multiplying the length of each connection between nodes by a weighting factor. In one embodiment the weighting factor is the number of wires in the connection.

When calculating the estimated shape of units, in accordance with one aspect of the invention, the area of units must be taken into account. If the units' location alone, expressed as a single point, is used then the optimal solution is usually to collapse the whole NoC into a single point.

According to another aspect of the present invention units are implemented as a sea of gates. Their shape is not limited to being rectangular or even contiguous. This is realistic of the final physical placement of gates within a completed chip layout.

According to another aspect of the present invention keep-out areas may be defined within the floorplan wherein units may not be placed. Furthermore, keep-out area constraints may be applied only to units with certain properties. One such property is power domain. Keep-out regions in portions of the chip can force placement of units in other portions where power rails from a particular power supply will be laid out.

Generally, the internal structure of gates of which each unit consists is unknown. In accordance with another aspect of the invention the floorplan estimation is made at the beginning of the project before the actual design is synthesized into gates or even described in a hardware description language.

### Formalism

n agents are node Nᵢ for 0≦i<n.

p units are node Nᵢ for n≦i<n+p.

Inputs:
Number of wires, λ_{i,j}, between nodes Nᵢ and Nⱼ for 0≦i<j<n+p
Shape, Sᵢ, of each agent for 0≦i<n
Area, σᵢ, of each unit for n≦i<n+p

Outputs:
Shape, Sᵢ, of each unit for n≦i<p such that

Sᵢ∩Sⱼ=0 for any i≠j (1)

L=ΣᵢΣⱼλ_{i,j}/(σᵢσⱼ)∫∫_{MεSi}∫∫_{NεSj}d(M,N)d²Md²N (2)

L minimum

∫∫_{MεSi}d²M=σᵢ for any n≦i<n+p (3)
d(M,N) is a distance of the plane.

Some examples of well-known methods of calculating distances are:

Euclidian d(M,N)=√(x_{M}−x_{N})²+(y_{M}−y_{N})²)

Manhattan d(M,N)=|x_{M}−x_{N}|+|y_{M}−y_{N}|

Infinite d(M,N)=max(|x_{M}−x_{N}|,|y_{M}−y_{N}|)

### Description

According to an aspect of the invention, the total length of wires L is minimized, considering that the distance between Nodes i and j is actually a function of the distance of all of the points of Nᵢ to all of the points of Nⱼ. The expected result of the optimal shapes of nodes comprises one or more loosely connected islands. Each comprising a set of nodes closely packed together. According to an aspect of the invention, the exact solving of such a system is expected to be NP-hard. According to another aspect of the invention, heuristics can be implemented.

In accordance with another aspect of the present invention, shapes Sᵢ may be further constrained geographically for example by one or more of the following parameters:
not to be overlap some other logic block;
to be confined to certain zones (typically related to power supply); and
to reflect reachable areas, considering signal speed (distance per unit time).

### Wire Map

Once all of the shapes Sᵢ are known, a median point is calculated for each shape. Referring to FIG. 8, point A and point B are median points within shape S₀ and S₁, respectively. A line is drawn from the median point of the shape of each node to the median point of the shape of each connected node as an overlay on the floorplan view. The thickness of the line indicates the number of wires between the endpoint nodes, wherein thicker lines represented higher numbers. An arrow head is drawn on the end of the line to indicate the direction of dataflow.

### Wire Density

Given all of the shapes Sᵢ, a wire density heat map is built. That is, a display of the area of the chip indicating the length of wire per unit area at each grid point. The wire density heat map is then multiplied by the metal pitch. This normalizes in the number of saturated metal layers.

In accordance with one aspect of the present invention, calculating wire density between the shapes, referring to FIG. 4, is:
for each node S₀
   for each connected node Sᵢ
      for each grid point A of node S₀
         for each grid point B of node S₁
         increment the density for each grid point C on the line between grid point A and grid point B.

According to an aspect of the invention, accuracy can be improved by accumulating to the density value an amount proportional to the number of wires in the connection between the nodes.

The method is further improved, in a finite element grid map of the floorplan, by using an anti-aliasing algorithm to determine, based on the vector of each line, the length of line within each pixel intersected by the line and weighting the amount of the increment by both the length of line within the grid point and the number of wires between the nodes. In accordance with one aspect of the present invention, the wire density is displayed by colors and displayed as an overlay on the chip floorplan.

### Logic Timing Path Estimation

According to another aspect of the invention, by knowing from the topology definition which nodes have pipeline stage registers that break combinatorial logic timing paths, the approximate route of combinatorial logic timing paths through the floorplan is calculated. Using an estimate of the delay based on wire length, weighted by wire density to account for parasitic capacitance, the signal propagation delay through the wires of each link connection between nodes is calculated. The propagation delay estimate is improved by including a model of logic delay through each node. This is approximated by a known approximate size of the area of each node. From the list of all calculated logic timing paths, the one with the greatest delay (i.e. the critical path) is estimated and its route drawn as an overlay of the chip floorplan. The drawing highlights the lines representing connectivity between nodes where the connection contains part of the critical path. A listing of logic timing paths, sorted by delay, is output as a report file.

### IO Constraint Generation

Given an estimate of the delay through wires, or such an estimate improved by an estimate of the delay through gates of logic timing paths between and through connected nodes, an estimate of the time at which signals will propagate into and out of the boundary of each node is calculated. This is performed by calculating the cumulative wire delay and logic delay before each unit sequentially within each logic timing path.

Referring to FIG. 9, node N₀ and node N₁ contain pipeline registers that are at the beginning and at the end of a combinatorial logic timing path that proceeds through node N₂. According to another aspect of the invention, the time at which the signal enters node N₂ and the time at which it is expected to exit node N₂ is used to generate IO timing constraints for those ports of the HDL modules for each node. The IO constraints are exported from the floorplan estimation software in a format that can be used as a timing constraint input to a logic synthesis tool. The logic synthesis tool uses the constraints to improve the achievable clock speed of the synthesized logic timing paths, particularly where those paths pass between regions of the chip that are synthesized separately.

### Power Estimation

According to another aspect of the invention, a sequence of traffic through the NoC design is simulated. The amount of information transferred on each connection link in the topology is recorded. As only information flowing between nodes is relevant, the simulation may be run at a high abstraction level and thus fast. This speed in turn enables statistically representative portion of traffic patterns to be simulated.

Assuming electric signals are not toggled unless a new word of information is presented; the number of toggles on each link is proportional to the amount of information. The power consumption induced is proportional to the number of toggles and proportional to the total parasitic capacitance of the each wire. As a first approximation the total parasitic capacitance of a wire is proportional to its length. A more precise estimation may be biased by the wire density along the wire route: in denser zones wires are closer one to another and the parasitic capacitance of each wire is increased. That results in an estimate of power consumption. The estimated power consumption is an output of the floorplan estimation for a given topology, floorplan, and toggling scenario.

Though the power consumption is proportional to the information transferred on wires, the power is dissipated through the transistors of the logic in the units. Given the calculation of information transferred by each unit through its connections, the units can be colored to indicate a heat map of estimated power dissipation throughout the chip.

The actual power consumption of a chip depends greatly on the process technology used to manufacture the chip. This power consumption estimate is independent of process technology and therefore an inaccurate prediction of actual power consumption. This power consumption estimate does not account for power dissipated by toggling of signals within the nodes. However, this estimate gives a reasonably accurate comparison of the actual power consumption of different topologies. The fact that the estimation is done independently of process technology is valuable for early stage comparisons and comparisons that explore topologies independently of implementation details.

The various aspects of the present invention may be implemented in software, hardware, application logic, or a combination of software, hardware, and application logic. The software, application logic and/or hardware may reside on a server, an electronic device, or a service. If desired, part of the software, application logic and/or hardware may reside on an electronic device, part of the software, application logic and/or hardware may reside on a server.

While the present invention has been described with reference to the specific applications thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

The foregoing disclosures and statements are illustrative only of the present invention, and are not intended to limit or define the scope of the present invention. The above description is intended to be illustrative, and not restrictive. Although the examples given include specifics, they are intended as illustrative of only certain possible applications of the present invention. The examples given should only be interpreted as illustrations of some of the applications of the present invention, and the full scope of the present invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

Although various aspects of the present invention are set out in the independent claims, other aspects of the invention comprise any combination of the features from the described embodiments and/or the dependent claims with the features of the independent claims, and not the solely the combination explicitly set out in the claims.

Unless defined otherwise, all technical and scientific terms used herein have the same meaning as commonly understood by one of ordinary skill in the art to which this invention belongs. Any methods and materials similar or equivalent to those described herein can also be used in the practice or testing of the present invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

What is claimed is:

1. One or more non-transitory computer readable media for storing computer-executable instructions that, when executed by a processor, cause the processor to perform a method for presenting a network-on-chip within the floorplan, which includes a plurality of points, of a semiconductor chip, the method comprising the steps of:
receiving a shape of at least one agent including at least one point selected from the plurality of points of the floorplan;
receiving a size of at least one unit;
determining a table of connectivity between a plurality of nodes; and
calculating a shape, which includes at least one point selected from the plurality of points of the floorplan, for the at least one unit, such that the total distance between each point of a node selected from the plurality of nodes and each point of at least one connected node, which is selected from the plurality of nodes and defined by the table, is minimized.

2. The one or more non-transitory computer readable media according to claim 1 wherein the method further comprises:
determining a number of wires of at least one connection; and
using the number of wires to weight the distance.

3. The one or more non-transitory computer readable medi according to claim 1 wherein the process further comprises:
determining a shape of at least one area wherein units may not be placed; and
constraining the step of calculating such that the shape of the at least one unit falls outside of the shape of the at least one area.

4. The one or more non-transitory computer readable media according to claim 3 wherein different constraints are applied to at least two units.

5. The one or more non-transitory computer readable media according to claim 1 wherein the process further comprises:
determining a shape of at least one area wherein wires may not be placed; and
constraining the step of calculating, such that a distance between two points is the one of a wire not crossing the shape of the at least one area.

6. The one or more non-transitory computer readable media according to claim 1, wherein shapes are calculated on points within a finite grid map.

7. The one or more non-transitory computer readable media according to claim 1, the method further comprising displaying a shape of at least one node selected from the plurality of nodes.

8. The one or more non-transitory computer readable media according to claim 1, the process further comprising displaying at least one line indicating connectivity of at least two nodes.

9. The one or more non-transitory computer readable medium according to claim 8, the method further comprising:
determining a plurality of wires for the connectivity; and
displaying the at least one line with a thickness corresponding to the number of wires.

10. The one or more non-transitory computer readable media according to claim 6, wherein the method further comprises displaying a wire density heat map within the finite grid map.

11. The one or more non-transitory computer readable media according to claim 10 wherein the step of displaying the wire density heat map comprises:
determining a plurality of wires for each of at least two connections;
calculating, for each connection, grid points on a line between connected nodes; and
accumulating a density value at a grid point corresponding to the connection lines that cross the grid point.

12. The one or more non-transitory computer readable media according to claim 11 wherein the step of displaying the wire density heat map depends on the number of the plurality of wires of each of the at least two connections.

13. The one or more non-transitory computer readable media according to claim 11 wherein the step of displaying the wire density heat map uses an anti-aliasing function.

14. The one or more non-transitory computer readable media according to claim 1 wherein at least one line is highlighted if a critical path occurs in its connection.

15. The one or more non-transitory computer readable media according to claim 1, the method further comprising:
determining a set of nodes selected from the plurality of nodes and their order in which a logic timing path occurs;
calculating a distance between each node within the set of nodes; and
calculating a cumulative signal propagation time for each node within the set of nodes.

16. The one or more non-transitory computer readable media according to claim 15, the method further comprising:
determining a logic timing path delay for each node within the set of nodes; and
adding to the cumulative signal propagation time for each node within the set of nodes the logic timing path delay of each previous node in the path.

17. The one or more non-transitory computer readable media according to claim 16, the method further comprising outputting signal propagation time information in a format that can be used as a timing constraint for synthesis.

18. The one or more non-transitory computer readable media according to claim 1, the method further comprising:
determining an amount of information traveling on at least one connection between nodes; and
multiplying the amount of information by the length of each connection.

19. The one or more non-transitory computer readable media according to claim 18, the method further comprising outputting a value of power consumed by the network-on-chip.

20. The one or more non-transitory computer readable media according to claim 18, the method further comprising outputting a value of the power consumed by each node.

21. The one or more non-transitory computer readable media according to claim 18, the method further comprising displaying a power consumption heat map within a finite grid map.

22. A method of designing a network on chip, the method comprising:
determining a topology;
determining a floorplan;
estimating the placement of a plurality nodes within the floorplan; and
modifying the topology in order to improve the placement of the plurality of nodes.

23. A method according to claim 22 further comprising displaying the plurality of nodes within the floorplan.

24. A method according to claim 22 further comprising displaying connections of the plurality of nodes within the floorplan.

25. A method according to claim 24, wherein the step of displaying is indicative of the number of wires in the connection.

26. A method according to claim 22 further comprising displaying a wire density heat map.

27. A method according to claim 22 further comprising displaying a critical timing path.

28. A method according to claim 22 further comprising outputting synthesis timing constraints.

29. A method according to claim 22 further comprising:
determining an amount of information; and
outputting a power consumption estimate.

30. A method according to claim 22 further comprising:
determining an amount of information; and
outputting a power consumption estimate for each unit.

31. A method according to claim 22 further comprising:
determining an amount of information; and
displaying a power consumption heat map.

32. A system including:
at least one processor; and
at least one memory unit in communication with the at least one processor, the at least one memory unit includes at least one computer program code and the at least one memory unit and the at least one computer program code, with the at least one processor, cause the system to present a network-on-chip within a floorplan, which includes a plurality of points, of a semiconductor chip through performing steps including:
receiving a first node's shape and size, wherein the first node is selected from a plurality of nodes and includes at least one point selected from the plurality of points of the floorplan;
receiving a second node's size, wherein the second node is selected from the plurality of nodes;
determining a table of connectivity between the plurality of nodes, wherein the table represents the connection between the plurality of nodes including the first node and the second node connectivity information; and
calculating the second node's shape, which includes at least one point selected from the plurality of points of the floorplan, such that the total distance between each point of the first node and each point the second node is minimized.
